(19) United States
(12) Patent Application Publication
(10) Pub. No.: US 2009/0032336 A1
(43) Pub. Date: Feb. 5, 2009

(54) Main Shaft-Lubricating Structure for a Direct Drive Torque Motor

(76) Inventors: Fu-Yuan Cheng, Taichung (TW); Chih-Hsien Chao, Taichung (TW)

Correspondence Address: Dr. BANGER SHIA, 102 Lindencrest Ct., Sugar Land, TX, 77479-5201, US

(21) Appl. No.: 11/833,968

(22) Filed: Aug. 3, 2007

(51) Int. Cl. F16N 29/00; F01M 7/00

(52) U.S. Cl. 184/6

(57) ABSTRACT

A main shaft-lubricating structure for a direct drive torque motor comprises a body, a direct drive torque motor, a main shaft, a bearing assembly, an adjustment nut and a brake assembly. The main shaft cooperates with the adjustment nut to fix the torque motor, the bearing assembly and the body. The bearing assembly utilizes the main bearing and the brake assembly to be supported between the body and the main shaft. The brake assembly and the body are defined with a first lubrication oil piping and a second lubrication oil piping, respectively. The first lubrication oil piping is communicated with the main bearing, and the second lubrication oil piping is communicated between the brake assembly and the main shaft. Thereby, with the abovementioned simplified structure, the main shaft can be lubricated, and the maintenance cost can be reduced.

### BACKGROUND OF THE INVENTION

1. Field of the Invention

The present invention relates to a lubrication structure for a direct drive torque motor, and more particularly to a main shaft-lubricating structure for a direct drive torque motor which can utilize a simplified structure to lubricate the main shaft and reduce the maintenance cost.

2. Description of the Prior Art

The motors are used more and more widely in modern industries, and there are categories of external rotor, internal rotor and so on. In addition to the high precision in the feeding transmission, the motor also has the advantages of low friction loss, high energy conversion efficiency and low noise, etc. Hence, the motor is obviously important to the modern industrial tool machines.

The existing direct drive torque motors are applied to the drive of the axis equipments, such as the automatic equipment, the indexing plate and each kind of tool machine. No matter how the configurations of various products are designed, between the direct drive torque motor and the main shaft are generally disposed many bearing structures, so that the smoothness of the rotating motion relative to each other can be maintained. Though the abovementioned design has been put into service, it still has many problems to be solved.

After the direct drive torque motor and the main shaft have operated for a certain time, the bearing structures for loading the direct drive torque motor and main shaft must be maintained and lubricated regularly by the operator. However, as for the bearings located inside the mechanism, they can be maintained after the whole mechanism is disassembled, thus increasing the maintenance cost.

In order to solve the abovementioned relevant problems, based on the accumulative research technology and experience in the field of the motor, from the angle of simplifying the design and adequately lubricating, the applicant of the present invention has developed a main shaft-lubricating structure for a direct drive torque motor.

### SUMMARY OF THE INVENTION

The primary objective of the present invention is to provide a main shaft-lubricating structure for a direct drive torque motor which can utilize a simplified structure to lubricate the main shaft and reduce the maintenance cost.

In order to achieve the abovementioned objective, the present invention utilizes the main shaft to cooperate with the adjustment nut to fix the torque motor, the bearing assembly and the body. The bearing assembly is supported between the body and the main shaft by the main bearing and the brake assembly. The brake assembly and the body are defined with a first lubrication oil piping and a second lubrication oil piping, respectively. The first lubrication oil piping is communicated with the main bearing, and the second lubrication oil piping is communicated between the brake assembly and the main shaft. Thereby, with the abovementioned simplified structure, the main shaft can be lubricated, and the maintenance cost can be reduced.

It is to be noted that, each of the first lubrication oil piping and the second lubrication oil piping is formed by linking up an oil-filling passage with an oil cavity. The oil cavity can be annular or column-shaped. The oil cavity of the first lubrication oil piping is located between the body and the main bearing, and the oil cavity of the second lubrication oil piping is located between the brake assembly and the main shaft.

The brake assembly includes a hollow pressure cylinder located between the body and the main shaft. The pressure is injected from the body side to make the pressure cylinder force the main shaft to offer the brake function. The abovementioned second lubrication oil piping is defined in the wall of the pressure cylinder. Such a technology is within the scope of the present invention.

### BRIEF DESCRIPTION OF THE DRAWINGS

FIG. 1 is a perspective view of a main shaft-lubricating structure for a direct drive torque motor in accordance with the present invention;

FIG. 2 is a cross sectional view of the main shaft-lubricating structure for a direct drive torque motor in accordance with the present invention; and

FIG. 3 is an enlarged cross sectional view of the main shaft-lubricating structure for a direct drive torque motor in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

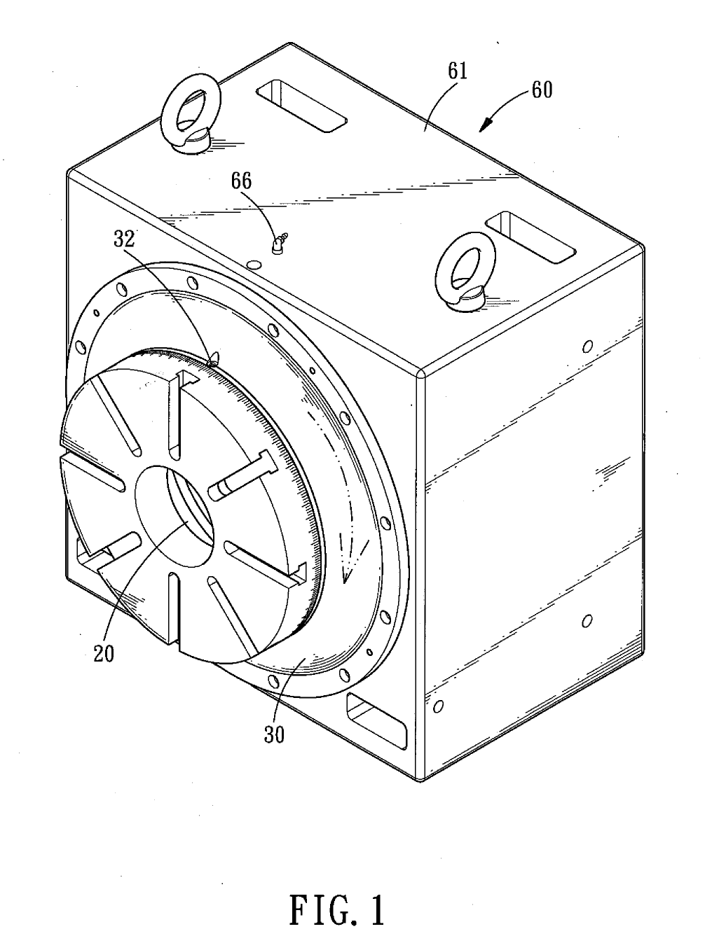

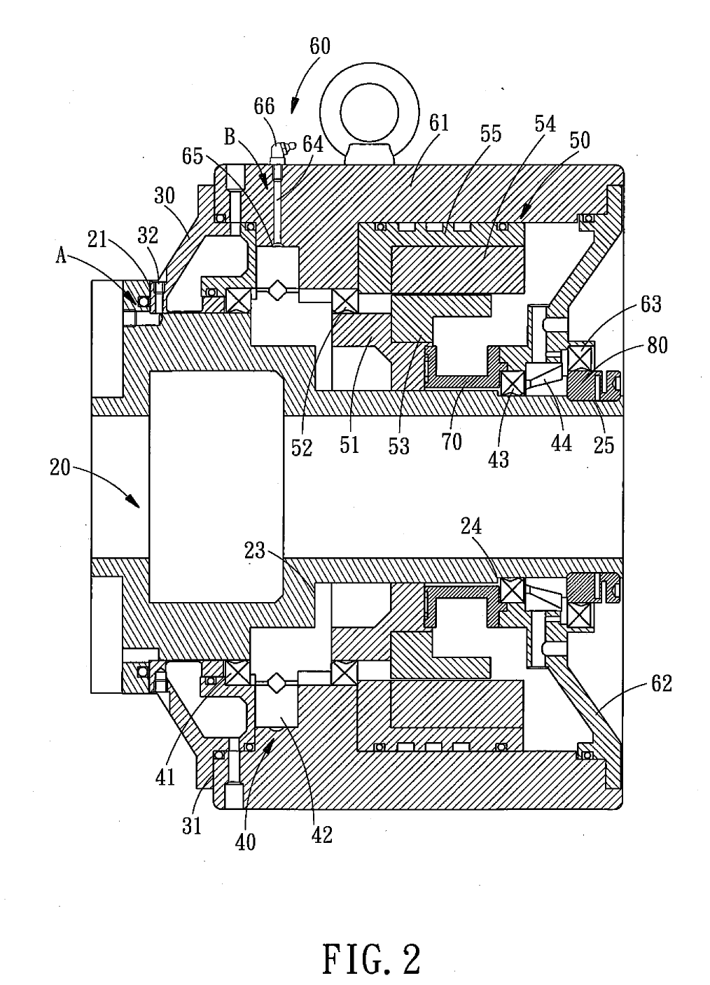

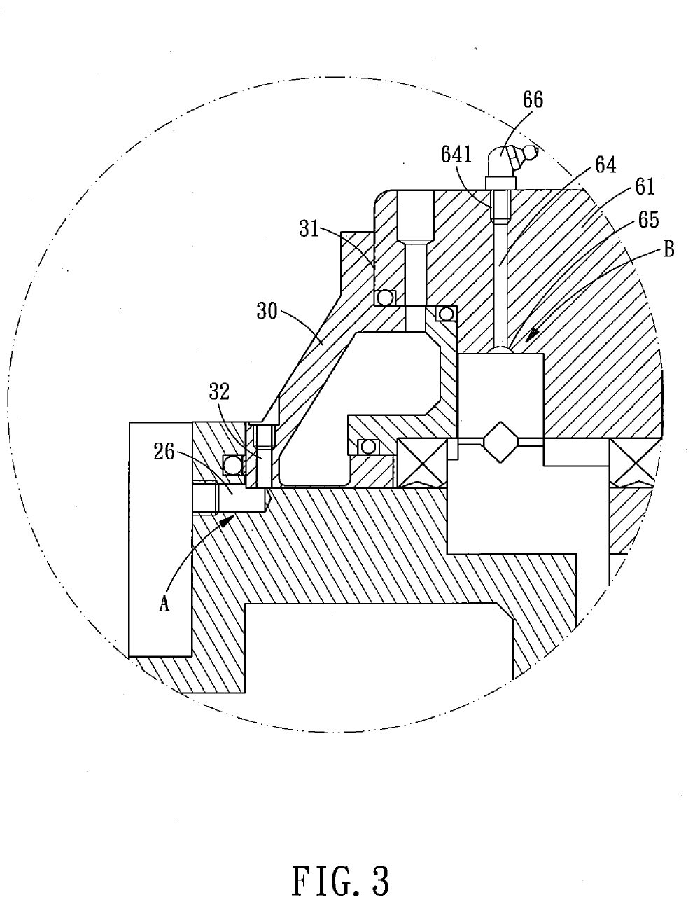

Referring to FIGS. 1-3, a main shaft-lubricating structure for a direct drive torque motor in accordance with a preferred embodiment of the present invention comprises a main shaft 20, a brake assembly 30, a bearing assembly 40, a direct drive torque motor 50, a body 60, a position-sensing assembly 70 and an adjustment nut 80.

The outer surface of the main shaft 20 includes a first stage 21, a second stage 22, a third stage 23, a fourth stage 24 and an external thread segment 25 that are successively tapered from one end to the other end of the main shaft 20. The external thread segment 25 is formed at one end of the main shaft 20, and the other end of the main shaft 20 is formed with a plurality of second column-shaped oil cavities 26. The outside open end of each second oil cavity 26 is sealed with a cover 261, and the second oil cavities 26 communicate with the first stage 21.

The inner side of the brake assembly 30 is positioned against the first stage 21 of the main shaft 20, and the outer side of the brake assembly 30 includes a positioning portion 31. In the wall of the brake assembly 30 is defined at least one second oil-filling passage 32. One end of the second oil-filling passage 32 is opened outwards, and the other end of the second oil-filling passage 32 is extended between the brake assembly 30 and the main shaft 20. The second oil-filling passage 32 is linked up with the second oil cavity 26 to form a second lubrication oil piping A.

The bearing assembly 40 includes a first oil seal 41, a main bearing 42, a second oil seal 43 and an assistant roller bearing 44. The first oil seal 41 is disposed between the brake assembly 30 and the main shaft 20. The main bearing 42 is located on the second stage 22 of the main shaft 20 and positioned against the brake assembly 30. The second oil seal 43 is located on the third stage 23 of the main shaft 20. The assistant roller bearing 44 is a tapered roller bearing and located on the fourth stage 24 together with second oil seal 43.

The direct drive torque motor 50 includes a mover-fixing seat 51, a mover oil seal 52, a mover 53, a stator 54 and a motor-cooling seat 55. The mover-fixing seat 51 is positioned against one side of the main bearing 42 of the bearing assembly 40. The mover oil seal 52 and the mover 53 are fixed at the outer side of the mover-fixing seat 51. The stator 54 is fixed in the motor-cooling seat 55 and the stator 54 is mounted on the mover 53.

The body 60 includes a shell member 61, a rear cover 62 and a rear cover oil seal 63. The shell member 61 is fixed with the rear cover 62. One end of the body 60 is fixed with the positioning portion 31 of the brake assembly 30. The body 60 and the main shaft 20 are positioned by the main bearing 42 of the bearing assembly 40. The body 60 is formed with a first lubrication oil piping B located correspondingly to the main shaft 20. The first lubrication oil piping B includes a first oil passage 64, a first oil cavity 65 and an oil nozzle 66. The first oil cavity 65 is an annular open space surrounding the outer side of the main bearing 42. One end of the first oil passage 64 is linked up with the first oil cavity 65, and the other end of the first oil passage 64 is extended outwards to form an open end 641. The oil nozzle 66 is screwed on the open end 641. The rear cover 62 of the body 60 is positioned outside the oil seal 43 and the assistant roller bearing 44 of the bearing assembly 40. The rear cover oil seal 63 is disposed on the inner side of the bottom of the rear cover 62. The shell member 61 is located outside for an accommodation of all the abovementioned assemblies and used for fixing the motor-cooling seat 55 of the direct drive torque motor 50.

The position-sensing assembly 70 is fixed on the rear cover 62 of the body 60 and used to sense the rotating position of the main shaft 20.

The adjustment nut 80 is screwed on the external thread segment 25 of the main shaft 20 and located in the rear cover oil seal 63 of the body 60. Moreover, the nut 80 is adjusted to press against the assistant roller bearing 44 of the bearing assembly 40.

The aforementioned is the summary of the positional and structural relationship of the respective components of the preferred embodiment in accordance with the present invention.

For a better understanding of the present invention, its operation and function are described as follows:

The end of the main shaft 20 is formed with a plurality of column-shaped second oil cavities 26, the outside open end of each second oil cavity 26 is sealed with the cover 26, and the second oil cavities 26 communicate with the first stage 21. The second oil cavity 26 cooperates with the second oil-filling passage 32 of the brake assembly 30 to form the second lubrication oil piping A, which can be directly injected with oil through the second oil-filling passage 32. Since the brake assembly 30 cannot rotate, the oil can directly fall into the second oil cavity 26 through the second oil-filling passage 32 and then be stored in the second oil cavity 26 for performing lubrication between the main shaft 20 and the brake assembly 30 at any moment.

In addition, after being injected into the first lubrication oil piping B of the body 60 from the oil nozzle 66, the oil will flow through the first oil passage 64 to the first oil cavity 65. Since the first oil cavity 65 is an annular open space surrounding the outer side of the main bearing 42, the oil will flow from up to down to surround the outside of the main bearing 42, and gradually penetrate into the main bearing 42 along with the running, at last, the oil will penetrate into the inner side of the main bearing 42, thus adequately realizing the lubrication between the body 60 and the main bearing 42 and further providing the lubrication between the main shaft 20 and the main bearing 42.

According to the abovementioned design, when the oil injection lubricating operation is to be performed in accordance with the present invention, the operator only needs to utilize the first lubrication oil piping B and the second lubrication oil piping A to perform the oil injection, so that the oil can be adequately injected in for lubricating the main bearing 42 and the main shaft 20, thus achieving the objective of utilizing the simplified structure to lubricate the main shaft and effectively reducing the maintenance cost.

While we have shown and described various embodiments in accordance with the present invention, it is clear to those skilled in the art that further embodiments may be made without departing from the scope of the present invention.

What is claimed is:

1. A main shaft-lubricating structure for a direct drive torque motor comprising a main shaft, a direct drive torque motor, a body, a bearing assembly, a brake assembly and an adjustment nut; wherein:
one end of the main shaft is formed with at least one second oil cavity, and an outside open end of each second oil cavity is sealed with a cover;
the direct drive torque motor is mounted on the main shaft;
the body is mounted on the direct drive torque motor and formed with at least one first lubrication oil piping which includes a first oil passage and a first oil cavity, one end of the first oil passage is linked up with the first oil cavity, and the other end of the first oil passage is extended outwards to form an open end;
the bearing assembly is disposed between the main shaft, the direct drive torque motor and the body and includes a main bearing located between the main shaft and the body, and the first oil cavity of the body is located outside the main bearing;
the brake assembly is located between the main shaft and the body and formed with at least one second oil-filling passage, one end of the second oil-filling passage is opened outwards, and the other end of the second brake assembly is extended between the brake assembly and the main shaft, the second oil-filling passage is linked up with the second oil cavity of the main shaft to form a second lubrication oil piping; and
the adjustment nut is fixed on the other end of the main shaft.

2. The main shaft-lubricating structure for a direct drive torque motor as claimed in claim 1, wherein the second oil cavity of the main shaft is column-shaped.

3. The main shaft-lubricating structure for a direct drive torque motor as claimed in claim 1 further comprising a position-sensing assembly, wherein:
an outer surface of the main shaft is formed with a first stage, a second stage, a third stage, a fourth stage and an outer thread segment that are successively tapered;
an inner side of the brake assembly is located on the first stage of the main shaft, and an outer side of the brake assembly includes a positioning portion;
the bearing assembly further includes a first oil seal, a second oil seal and an assistant roller bearing, the first oil seal is disposed between the brake assembly and the main shaft, the main bearing is located on the second stage of the main shaft and positioned against the brake assembly, the second oil seal is located on the third stage of the main shaft, the assistant roller bearing is located on the fourth stage of the main shaft and positioned against the second oil seal;
the direct drive torque motor includes a mover-fixing seat, a mover oil seal, a mover, a stator and a motor-cooling seat, the mover-fixing seat is positioned against one side of the main bearing of the bearing assembly, the mover oil seal and the mover are fixed outside the mover-fixing seat, the stator is installed in the motor-cooling seat and mounted on the mover;
the body further includes a shell member, a rear cover and a rear cover oil seal, the shell member and the rear cover are fixed with each other, one end of the body is fixed with the positioning portion of the brake assembly, the body and the main shaft are positioned by the bearing assembly, the rear cover of the body is located outside the second oil seal and the assistant roller bearing of the bearing assembly, an inner inside of a bottom of the rear cover is disposed with the rear cover oil seal, the shell member is located outside for an accommodation of all the abovementioned components and used for fixing the motor-cooling seat of the direct drive torque motor;
the position-sensing assembly is fixed on the rear cover of the body and used for sensing rotating position of the main shaft.

4. The main shaft-lubricating structure for a direct drive torque motor as claimed in claim 1, wherein the first oil cavity of the body is an annular open space surrounding an outer side of the main bearing, and the first oil passage is extended outwards to form an open end, a nozzle is screwed on the open end of the first oil passage.

5. The main shaft-lubricating structure for a direct drive torque motor as claimed in claim 1, wherein the brake assembly includes a hollow pressure cylinder, and the second oil-filling passage of the brake assembly is formed in a wall of the pressure cylinder.
